(19) United States
(12) Patent Application Publication
(10) Pub. No.: US 2006/0106779 A1
(43) Pub. Date: May 18, 2006

(54) Apparatus and method for deleting/retransmitting media data in a mobile communication terminal

(75) Inventor: Keun-Hee Kim, Sasang-gu (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/128,240

(22) Filed: May 13, 2005

(30) Foreign Application Priority Data
Nov. 1, 2004 (KR) 2004-87936

(51) Int. Cl. G06F 17/30; G06F 7/00

(52) U.S. Cl. 707/3

(57) ABSTRACT

Disclosed is an apparatus and method for deleting/retransmitting media data stored in a mobile communication terminal. The apparatus and method comprise: entering a media data deletion/retransmission mode; displaying media data folders according to types of media data for receiving a user selection; receiving a search condition for searching for specific media data in the selected media data folder; extracting and displaying media data relating to the received search condition; and deleting/retransmitting the extracted media data.

### PRIORITY

This application claims the benefit under 35 U.S.C. 119(a) of an application entitled “Method For Deleting/Retransmitting Media Data In Mobile Communication Terminal” filed in the Korean Intellectual Property Office on Nov. 1, 2004 and assigned Serial No. 2004-87936, the entire contents of which are incorporated herein by reference.

### BACKGROUND OF THE INVENTION

1. Field of the Invention

The present invention relates to an apparatus and method for efficiently deleting/retransmitting media data such as a text message stored in a mobile communication terminal. More particularly, the present invention relates to an apparatus and method for deleting/retransmitting media data such as a text message by using the search conditions received from a user.

2. Description of the Related Art

As is generally known in the art, due to the rapid growth of mobile communication terminals, the majority of communication generated among people is performed through mobile communication terminals. As a result, the mobile communication terminal is being recognized as an essential communication means in present-day life. The recent rapid progress in electronics and communication engineering has enabled mobile communication terminals to have various functions. In other words, based on the rapid development of radio communication and data processing, men/women can be provided with not only a voice communication function but also a text message transmission function such as short message service (SMS), a moving-picture message transmission function and the like, using the mobile communication terminal.

Recently, a caller identification (CID) service has been provided, which enables the caller's telephone number and time of the call to be displayed on a display unit of a receiver's mobile communication terminal and to be stored in the receiver's mobile communication terminal. Consequently, all telephone numbers and messages transmitted/received from/to a mobile communication terminal are stored in the mobile communication terminal, which may cause an invasion of personal privacy if the information is failed to be deleted at the proper time. That is, telephone numbers and messages stored in the mobile communication terminal as described above comprise telephone numbers or messages, either which are important in business or personally for the user of the mobile communication terminal or which require protection from fraudulent use or abuse. If the user finds and deletes such telephone numbers and messages one by one, there is a danger of revealing them to other persons. Therefore, in order to prevent such a danger, the user of the mobile communication terminal must find and delete telephone numbers and messages having been stored in the mobile communication terminal's daily communication and message list one by one, which decreases user friendliness. Also, in the prior art, there is no method of collectively retransmitting found text messages and the like to a specific terminal before they are deleted, when necessary.

### SUMMARY OF THE INVENTION

Accordingly, the present invention has been made to solve the above-mentioned problems occurring in the prior art, and an object of the present invention is to provide an apparatus and method capable of efficiently selecting and deleting a text message and the like stored in a mobile communication terminal.

Another object of the present invention is to provide a search algorithm for efficiently deleting a text message and the like so as to improve user convenience in a deletion interface function.

Still another object of the present invention is to provide an apparatus and method capable of retransmitting a found text message and the like to a specific terminal.

To accomplish these objects, in accordance with one aspect of the present invention, there is provided an apparatus and method for deleting/retransmitting media data stored in a mobile communication terminal. The apparatus and method comprise entering a media data deletion/retransmission mode; displaying media data folders according to types of media data for receiving a user selection; receiving a search condition for searching for specific media data in the selected media data folder; extracting and displaying media data relating to the received search condition; and deleting/retransmitting the extracted media data.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a mobile communication terminal according to an embodiment of the present invention;

FIG. 2 is a flowchart illustrating a procedure of deleting media data according to an embodiment of the present invention;

FIG. 3 is a flowchart illustrating display windows of the mobile communication terminal in a detailed procedure of deleting/retransmitting text messages from among media data according to an embodiment of the present invention; and

FIG. 4 is a flowchart illustrating a procedure of deleting a communication item according to an embodiment of the present invention.

Throughout the drawings, the same element is designated by the same reference numeral or character.

### DETAILED DESCRIPTION OF EXEMPLARY EMBODIMENTS

Hereinafter, embodiments of the present invention will be described with reference to the accompanying drawings. In the following description of the present invention, a detailed description of known functions and configurations incorporated herein will be omitted for conciseness. In the following, specific embodiments of the present invention will be described to provide an understanding of the present invention. It will be understood by those skilled in the art that various changes in form and detail may be made within the scope of the present invention.

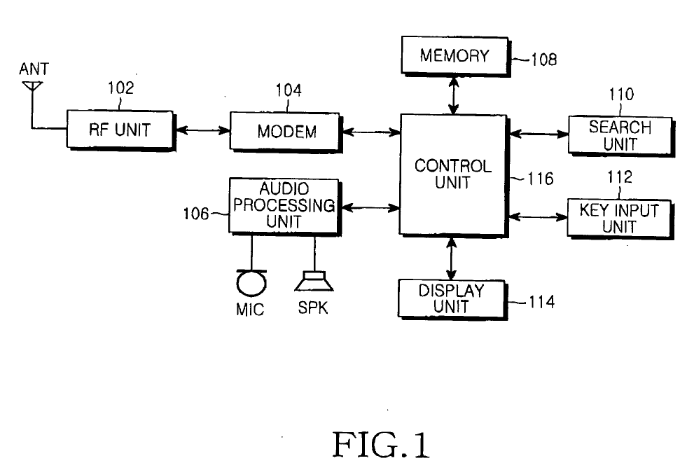

FIG. 1 is a block diagram illustrating a construction of a mobile communication terminal according to an embodiment of the present invention. A Radio Frequency (RF) unit 102 performs a wireless communication function for the mobile communication terminal. The RF unit 102 includes an RF transmitter (not shown) and an RF receiver (not shown). The RF transmitter up-converts and amplifies the frequency of a signal to be transmitted and the RF receiver low-noise amplifies a received signal and down-converts the frequency of the received signal. A modem (modulator and demodulator) 104 includes a transmitter (not shown) for encoding and modulating a signal to be transmitted, and a receiver (not shown) or decoding and demodulating a received signal.

An audio processing unit 106 may comprise a codec, which comprises a data codec for processing packet data and the like and an audio codec for processing an audio signal such as voice. The audio processing unit 106 converts a digital audio signal received from the modem 104 into an analog signal by means of the audio codec, thereby reproducing the converted analog signal. Also, the audio processing unit 106 converts an analog audio signal for transmission generated from a microphone into a digital audio signal by means of the audio codec and transmits the converted digital audio signal to the modem 104.

A memory 108 may comprise a program memory and a data memory. The program memory stores an operating system (OS) for driving the mobile communication terminal and various programs for controlling the operation of each component in the mobile communication terminal. The data memory is implemented with a nonvolatile memory such as a flash memory or the like which stores personal information media data. That is, the data memory stores media data relating to personal information, such as called telephone numbers, received telephone numbers, a phone book, sent messages, received messages and the like. From among these media data, a specific media data is detected by a search unit according to search conditions and the detected media data becomes a subject to be deleted.

The search unit 110 searches a specific media data relating to search conditions input by the user. For example, when the user inputs “Hong Gil Dong and business registration number” as search conditions in a text message folder, the search unit 110 finds and displays a text message relating to the input search conditions from among all text messages stored in a receive folder, a send folder and a reserve folder.

A key input unit 112 includes a key pad of the mobile communication terminal and functions to receive characters. A display unit 114 includes a display window showing an image of the mobile communication terminal and displays found media data.

A control unit 116 functions to control the respective components. Particularly, the control unit 116 includes an algorithm that displays media data found according to search conditions and deletes media data selected for deletion by the user.

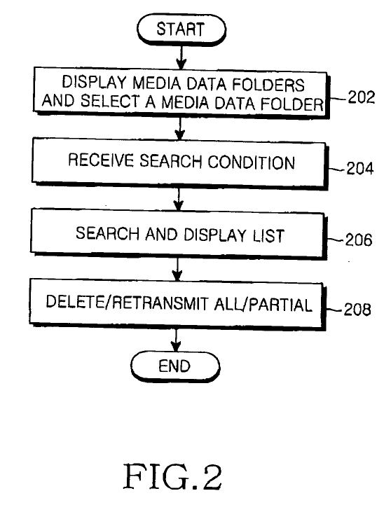

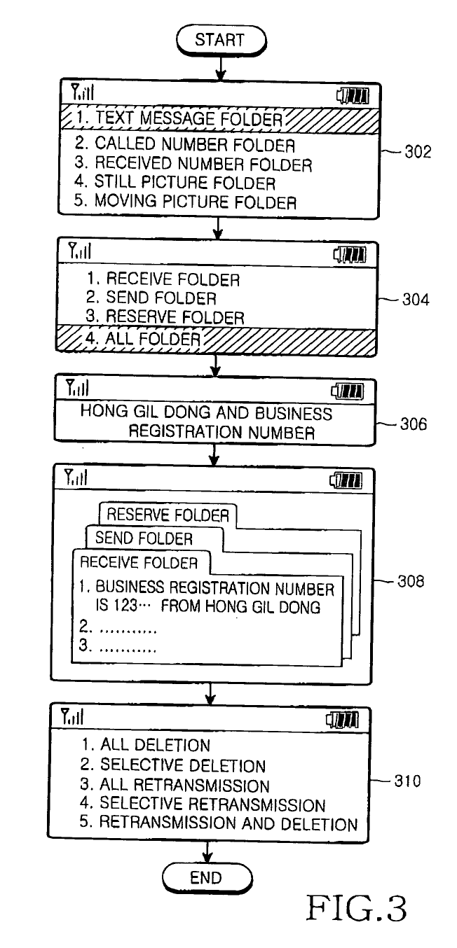

FIG. 2 is a flowchart illustrating a procedure of deleting media data through a search according to an embodiment of the present invention. First, when the mobile communication terminal enters a deletion/retransmission mode, the mobile communication terminal displays media data folders to be deleted/retransmitted and then receives from the user information about the selected folder to be deleted/transmitted in step 202. Specifically, as shown in step 302 of FIG. 3, the mobile communication terminal displays media data folders, such as a text message folder, a called telephone number folder, a received telephone number folder, a still picture folder, a moving picture folder and the like, and receives from the user information about the selected folder to be deleted/transmitted. When such a selection has been performed, a search is performed only for the selected media data folder. Hereinafter, the data of the text message, the called telephone number, the received telephone number, the still picture, the moving picture and the like will be called ‘media data’. That is, in the following description, ‘media data’ are defined as a term which represents all data including characters, telephone numbers, pictures and the like to be stored in the mobile communication terminal.

After a media data folder to be deleted/retransmitted is selected in step 202, search conditions are input. For instance, when the text message folder has been selected in step 202, the search unit 110 receives search conditions from the user in step 204 for the purpose of extracting a text message to be deleted/retransmitted from among text messages included in the text message folder. A variety of search conditions may be input. For example, search conditions for a text message may comprise a text message caller's telephone number, a text message caller's name, a specific character in text message content, a text message reception time and the like.

Search conditions according to each media data are shown as examples in Table 1 below.

TABLE 1

| | Media Data to be | |
|---|---|---|
| | Deleted | Search Conditions according to Each category |
| 1 | Text Message | Caller telephone number, Caller name, Specific |
| | | character |
| 2 | Called Telephone | Called telephone number, Calling time, |
| | Number | Called name |
| 3 | Received Telephone | Received telephone number, Reception time, |
| | Number | Received name |
| 4 | Still Picture | Still picture item number, Still picture |
| | | registration title |
| 5 | Moving Picture | Moving picture item number, Moving picture |
| | | registration title |

Meanwhile, such a search may be performed not only with one search condition but also with a combination using various search conditions. For instance, when the users desires to find a text message having the term ‘business registration number’ from among text messages sent by ‘Hong Gil Dong’, a detailed search thereof can be performed by inputting ‘Hong Gil Dong and business registration number’ as search conditions.

After the search conditions are input as described above, the search unit 110 performs a search according to the input search conditions and then displays the found items as a list in step 206. When the user sees the displayed list and selects deletion or retransmission of at least one item in the list, the mobile communication terminal deletes or retransmits the relevant item in step 208, thereby completing a media data deletion or retransmission operation through a search. The term “retransmission” represents transmission to another terminal and refers to transmit found media data to a terminal of a telephone number input by the user. As described above, the user can easily find and retransmit desired media data to a specific terminal, thereby efficiently sharing information stored in the own terminal with another terminal.

Meanwhile, step 208 for deletion/retransmission may be performed as an entire deletion step of deleting all of the found media data, or may be performed as a selective deletion step of selecting and deleting a portion of the found item. Also, step 208 for deletion/retransmission may be realized to perform only a single operation of the deletion and retransmission operations, or may be realized to perform the deletion operation simultaneously with the retransmission operation.

FIG. 3 is a detailed flowchart of the flowchart shown in FIG. 2. Specifically, FIG. 3 is a flowchart illustrating display windows of the mobile communication terminal according to steps, with respect to an example of deleting/retransmitting a text message from among various media data. In the deletion/retransmission mode, the mobile communication terminal receives a text message folder for deletion/retransmission from the user in step 302. That is, the mobile communication terminal displays the text message folder, the called telephone number folder, the received telephone number folder, the still picture folder, the moving picture folder, and receives from the user information about the selected folder to be deleted/transmitted.

When the user has selected the text message folder in step 302, the mobile communication terminal receives the selection of one folder, which includes a text message to be found for deletion/retransmission, from among the receive folder, the send folder and the reserve folder for text messages in step 304. When the user selects a whole folder including the receive folder, the send folder and the reserve folder, the search unit 110 performs a search with respect to all text messages included in all folders (the receive folder, the send folder and the reserve folder). For instance, when the user inputs ‘Hong Gil Dong and business registration number’ as search conditions in step 306, the mobile communication terminal finds and displays text messages relating to the input search conditions, from among all text messages included in the receive folder, the send folder and the reserve folder, in step 308.

In step 310, the user can select to delete/retransmit all or a portion of the text messages displayed in step 308. If the user selects a selective deletion mode, the mobile communication terminal can selectively delete found text messages by selecting desired text messages according to the operation of direction keys. Also, the user selects a deletion/retransmission mode, the mobile communication terminal retransmits a found text message to a terminal of a telephone number desired by the user, and then performs a deletion operation of the relevant text message.

Meanwhile, the procedures illustrated in flowcharts of FIGS. 2 and 3 show the respective steps with respect to a case in which the mobile communication terminal enters the deletion/retransmission mode. However, according to another embodiment of the present invention, it is possible for search conditions to be input directly in a relevant media data folder, without the selection of the deletion/retransmission mode by the user. That is, the deletion or retransmission operation can be performed through a direct search in a communication list display window or in a text message list display window.

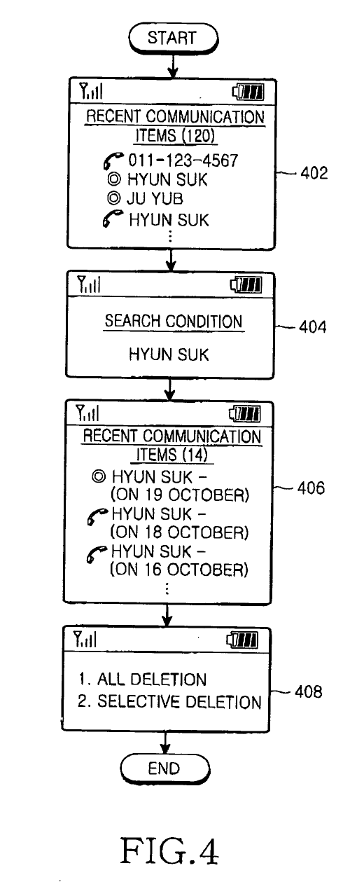

FIG. 4 is a flowchart illustrating a deletion/retransmission procedure through a search in a communication list according to an embodiment of the present invention. Generally, when the user presses a communication key, the mobile communication terminal displays a recent communication list in step 402. In such a display state, the mobile communication terminal provides a deletion/retransmission menu key. When the user presses the deletion/retransmission menu key, the mobile communication terminal provides a search input field to receive search conditions from the user in step 404. If the user inputs ‘Hyun Suk’ as a search condition, the search unit 110 searches for communication items including the character ‘Hyun Suk’ from among communication items and then displays found communication items with duration of each communication in step 406. Then, the mobile communication terminal receives the user's selection for specific communication items of the displayed communication items in step 408 and deletes/retransmits the selected communication items.

Meanwhile, in the above-mentioned steps, step 404 of receiving search conditions from the user in performed after a recent communication list is displayed in step 402. However, it is possible to display a communication list for deletion without step 404 for receiving search conditions. That is, when the user positions the cursor at a field of ‘Hyun Suk’ and presses a predetermined deletion key in step 402, communication items including the character ‘Hyun Suk’ are displayed as shown in step 406. By such a scheme, it is possible to select communication items for deletion without a separate search condition.

While the present invention has been shown and described with reference to certain embodiments thereof, it will be understood by those skilled in the art that various changes in form and details may be made therein without departing from the spirit and scope of the invention as defined by the appended claims.

What is claimed is:

1. A method for deleting/retransmitting media data stored in a mobile communication terminal, the method comprising the steps of:
entering a media data deletion/retransmission mode;
displaying media data folders according to types of media data for receiving a user selection;
receiving a search condition for searching for specific media data in the selected media data folder;
extracting and displaying media data relating to the received search condition; and deleting/retransmitting the extracted media data.

2. The method as claimed in claim 1, wherein the media data comprises any one of a text message, a user name, a telephone number, a still picture and a moving picture.

3. The method as claimed in claim 1, wherein the step of deleting/retransmitting the extracted media data is performed to selectively delete/retransmit a portion of the extracted media data.

4. The method as claimed in claim 1, wherein the search is performed using a combination of search conditions.

5. The method as claimed in claim 1, wherein all or portions of a folder are deleted.

6. The method as claimed in claim 1, wherein all or portions of a folder are retransmitted.

7. A method for deleting/retransmitting media data stored in a mobile communication terminal, the method comprising the steps of:
receiving a search condition directly in a specific media data folder display window;
extracting and displaying media data relating to the received search condition; and
deleting/retransmitting the extracted media data.

8. The method as claimed in claim 7, wherein the media data comprises any one of a text message, a user name, a telephone number, a still picture and a moving picture.

9. The method as claimed in claim 7, wherein the step of deleting/retransmitting the extracted media data is performed to selectively delete/retransmit a portion of the extracted media data.

10. The method as claimed in claim 7, wherein the search is performed using a combination of search conditions.

11. The method as claimed in claim 7, wherein all or portions of a folder are deleted.

12. The method as claimed in claim 7, wherein all or portions of a folder are retransmitted.

13. A method for deleting/retransmitting media data stored in a mobile communication terminal, the method comprising the steps of:
selecting specific media data items from among media data items displayed in a specific media data folder display window;
extracting and displaying media data relating to a title of the selected media data item; and
deleting/retransmitting the extracted media data.

14. The method as claimed in claim 13, wherein the media data comprises any one of a text message, a user name, a telephone number, a still picture and a moving picture.

15. The method as claimed in claim 13, wherein the step of deleting/retransmitting the extracted media data is performed to selectively delete/retransmit a portion of the extracted media data.

16. The method as claimed in claim 13, wherein the search is performed using a combination of search conditions.

17. The method as claimed in claim 13, wherein all or portions of a folder are deleted/retransmitted.

18. An apparatus for deleting/retransmitting media data stored in a mobile communication terminal, comprising:
a key input unit for entering a media data deletion/retransmission mode;
a display for displaying media data folders according to types of media data for receiving a user selection; and
a controller for receiving a search condition for searching for specific media data in the selected media data folder, extracting and displaying media data relating to the received search condition and deleting/retransmitting the extracted media data.

19. The apparatus as claimed in claim 18, wherein the media data comprises any one of a text message, a user name, a telephone number, a still picture and a moving picture.

20. The apparatus as claimed in claim 18, wherein the controller selectively deletes/retransmits a portion of the extracted media data.
